(19) United States
(12) Patent Application Publication
(10) Pub. No.: US 2003/0225818 A1
(43) Pub. Date: Dec. 4, 2003

(54) Network integrated device electronics (IDE) technology

(76) Inventor: Remesh S. Nair, Penang (MY)

Correspondence Address: Pillsbury Winthrop LLP, Intellectual Property Group, 725 South Figueroa Avenue, Los Angeles, CA, 90017, US

(21) Appl. No.: 10/158,262

(22) Filed: May 30, 2002

(51) Int. Cl. G06F 15/16

(52) U.S. Cl. 709/200

(57) ABSTRACT

A universal conversion system is utilized to allow a computing device to access a remote computing device. A receiving module within the universal conversion system receives storage device access signals from an input/output device. A conversion module within the universal conversion system converts the storage device access signals to network interface signals. An output module within the universal conversion system transmits the network interface signals.

### BACKGROUND

1. Technical Field

This invention relates generally to the field of diskless computing devices, and more specifically, to a system, method, and apparatus to allow a diskless computing device to access files on remote computing devices without modifying the operating system software.

2. Discussion of the Related Art

Diskless computing devices may load operating system and application software from remote computing devices, e.g., servers, which are located on a network. In an organization utilizing diskless computing devices, computing support departments do not need to worry about multiple copies of different versions of operating systems or applications programs being resident on the plurality of computing devices on the organization's networks. Therefore, less maintenance is required because the software loaded into the computing devices is stable and known to the computer support department.

If a diskless computing device utilizes remote booting, it may load the operating system into its RAM in order to begin operation. Because diskless computing devices do not usually include, and therefore use, a storage device within the diskless computing device for booting, a more robust system is available because the possibility that the storage device may fail is eliminated. In order to load the operating system into RAM, the entire diskless computing device operating system path may need to be changed from a directory on the computing device storage device to a remote computing device's shared directory.

A problem with modification of the diskless computing device operating system path is that the modification is very operating system dependent, meaning the process is different for each operating system enabled, and the process may be costly and time-extensive. In some remote booting solutions, the operating system registry or kernel settings have to be modified to enable remote booting. The modification of the operating system registry or kernel settings may take a large amount of development time and may also require time for validation.

Similarly, in diskless computing devices, each time the processor needs to access additional software, such as application software, the diskless computing device needs to access the remote computing device. For example, a processor in the diskless computing device may request a file that is located on a remote computing device and the processor would forward the request to an input/output device. Because the operating system path has been altered, the input/output device would communicate with the remote computing device via a network interface device.

### BRIEF DESCRIPTION OF THE DRAWINGS

FIG. 1 illustrates a computing device accessing a remote computing device according to an embodiment of the present invention;

FIG. 2 illustrates a universal conversion system sending information to a remote computing device according to an embodiment of the present invention;

FIG. 3 illustrates a universal conversion system receiving information from a remote computing device according to an embodiment of the present invention;

FIG. 4 illustrates a flowchart for a universal conversion system transmitting information to a remote computing device according to an embodiment of the present invention; and

FIG. 5 illustrates a flowchart for a universal conversion system receiving information from a remote computing device according to an embodiment of the present invention.

### DETAILED DESCRIPTION

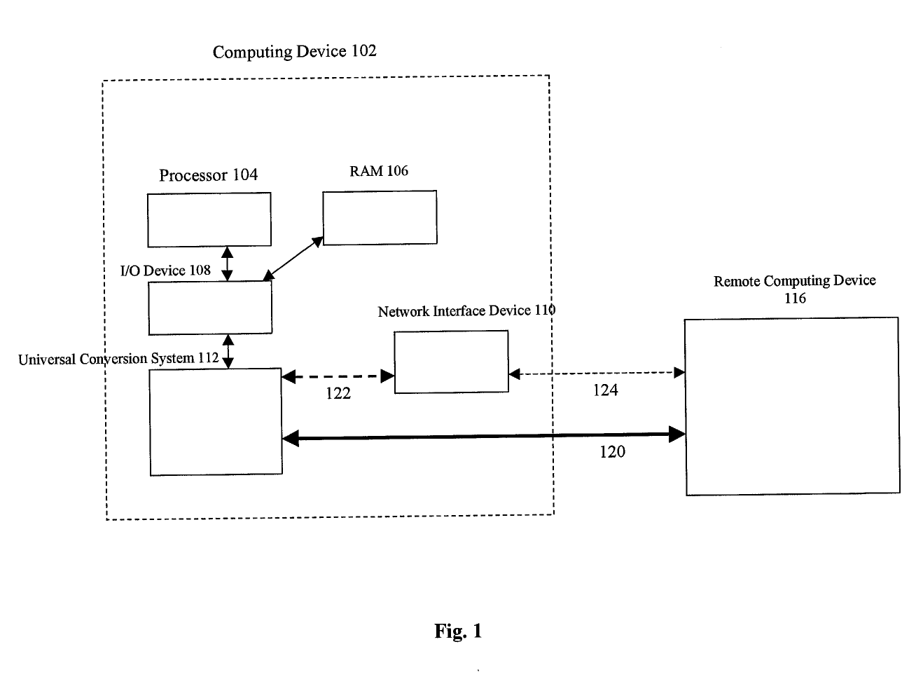

FIG. 1 illustrates a computing device accessing a remote computing device according to an embodiment of the present invention. The computing device 102 may include a processor 104, random access memory (RAM) 106, an input/output (I/O) device 108, a network interface device 110, and a universal conversion system 112. The computing device 102 may communicate with a remote computing device 116 through the network interface device 110 utilizing a network communications protocol, such as Transmission Control Protocol (Transmission Control Protocol, Internet Engineering Task Force/Information Sciences Institute, RFC 793, September 1981)/Internet Protocol (Internet Protocol, Internet Engineering Task Force/Information Sciences Institute, RFC 791—Version 4—December 1981, RFC 2460—Version 6—December 1998) (TCP/IP), Ethernet (Carrier Sense Multiple Access/Collision Detection Access Method, Institute of Electrical and Electronic Engineers, 802.3-2002, Mar. 8, 2002), or Token Ring, (Token Ring Access Method, Institute of Electrical and Electronic Engineers, 802.5w-2000, Corrigendum to IEEE Std 802-5: 1998) in the form of network interface signals, as illustrated by path 124. In an alternative embodiment of the present invention, the computing device may communicate with the remote computing device 116 through the universal conversion system 112, as illustrated by path 120, utilizing a network communications protocol such as the ones described above.

The RAM 106 may be dynamic random access memory (DRAM), synchronous DRAM (SDRAM), or any other suitable memory device. The computing device 102 may be, for example, a personal computer, an industrial personal computer, a laptop, or a personal digital assistant (PDA). The computing device 102 may or may not include a storage device. In an embodiment of the invention, the primary storage device, i.e., the storage device that includes an operating system, may not be located within the computing device 102. In such embodiments of the invention, the primary storage device may be located in the remote computing device 116. The remote computing device 116 may be, for example, a server, a personal computer, a laptop, or a mainframe computer.

In one embodiment of the present invention, the processor 104 may request data that is located on the remote storage device located in the remote computing device 116. The processor 104 may not realize that the storage device is not local. The processor 104 may generate storage device request signals and may transmit the storage device request signals to the I/O device 108. In this embodiment of the present invention, the I/O device 108 may receive the storage device request signals and transmit storage device access signals to the universal conversion system 112.

The I/O device 108 may be an I/O controller. Illustratively, the I/O controller may be an Intel I/O Controller Hub (Intel 82801AA (ICH) and Intel 82801AB (ICHO) Specification, November 2001, Intel). In an alternative embodiment of the present invention, the processor 104 may communicate directly, i.e, transmit storage device access signals, to the universal conversion system 112.

In an embodiment of the present invention, the universal conversion system 112 may receive the storage device access signals from the I/O device 108. In one embodiment of the present invention, the universal conversion system 112 may convert the storage device access signals to network interface signals, i.e., signals that are compliant with a network protocol. The universal conversion system 112 may transmit the network interface signals over a communications network to the remote computing device 116. The remote computing device 116 may receive the network interface signals and retrieve data that the processor 104 requested.

In this embodiment of the present invention, the remote computing device 116 may package the data requested by the processor 104 into response network interface signals and transmit the response network interface signals to the universal conversion system 112 via a communications network. The universal conversion system 112 may receive the response network interface signals, convert the response network interface signals to storage device response signals, and transmit the storage device response signals to the input/output device 108. The input/output device 108 may receive the storage device response signals and pass the storage device response signals 108 to the processor 104. In this embodiment of the invention, the ability to obtain data from the remote computing device 116 may occur without modification to the operating system kernel or device drivers, so the solution may be operating system independent. Through the use of this embodiment of the invention, the storage device access signals may be converted to network interface signals utilizing the typical software stack on the Network Interface as illustrated below.

Client/Server Application
DHCP, FTP, TFTP, MTFTP, etc.
Socket Layer
TCP, UDP, ICMP, IGMP, etc.
IP, ARP, etc.
Universal Protocol Drivers
Network Interface
UNIVERSAL CONVERSION SYSTEM
Storage Device Access Hardware-Storage Device Access
or Response Signals

The processor 104 may make the request for data as part of a booting/initialization process, a storage device read/write process, or a storage device caching process. In an alternative embodiment of the present invention, the input/output device 108 may pass the storage device response signals to the RAM 106 without utilizing the processor 104. This may be referred to as Direct Memory Access (DMA).

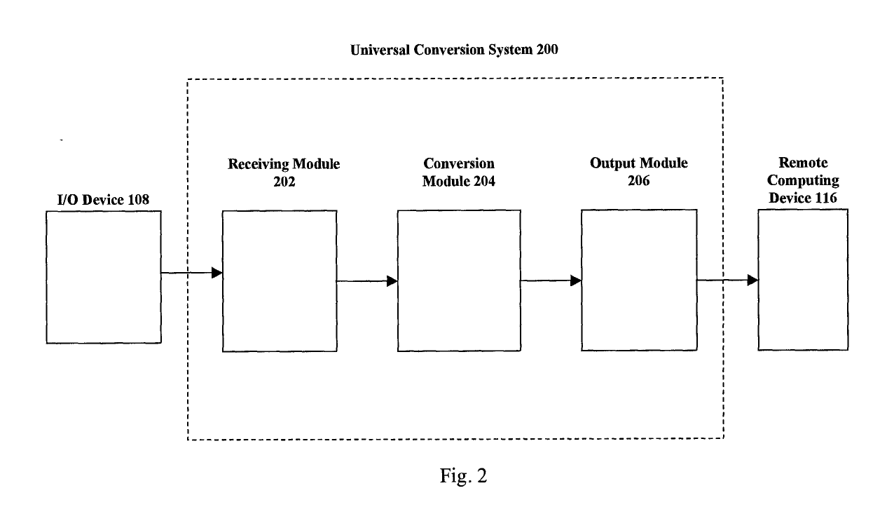

FIG. 2 illustrates a universal conversion system for sending information to a remote computing device according to an embodiment of the present invention. The universal conversion system 200 may include a receiving module 202, a conversion module 204, and an output module 206. In one embodiment of the present invention, the receiving module 202 in the universal conversion system 200 may receive storage device access signals from the I/O device 108. The receiving module 202 may transfer the storage device access signals to the conversion module 204. The conversion module 204 may convert the storage device access signals to network interface signals. The conversion module 204 may transfer the network interface signals to the output module 206. The output module 206 may transmit the network interface signals to the remote computing device 116. The universal conversion system 200 may be housed in, for example, one of an application specific integrated circuit (ASIC), a programmable logic controller (PLC), or a read-only memory (ROM). In one embodiment of the present invention, the universal conversion system may be housed in the network interface device 110. In one embodiment of the present invention, the storage device access signals may be Integrated Drive Electronics (IDE/ATA/ATAPI-5 Interface Standard, National Committee for Information Technology, Standard Number NCITS 340-2000, 2000) (IDE) signals. In an embodiment of the present invention, the network interface signals may be Transmission Control Protocol/Internet Protocol (TCP/IP) signals.

In an alternative embodiment of the present invention, the receiving module 202 in the universal conversion system 200 may receive the storage device access signals and transfer the storage device access signals to the conversion module 204. The universal conversion module 204 may convert the storage device access signals to peripheral interface signals and then convert the peripheral interface signals to network interface signals. In this embodiment of the present invention, the conversion module 204 may transfer the network interface signals to the output module 206, which transmits the network interface signals to the remote computing device 116. In an embodiment of the present invention, the universal conversion system 200 may be housed in the network interface device 110. In one embodiment of the present invention, the storage device access signals may be Integrated Drive Electronics (IDE) signals. The network interface signals may be Transmission Control Protocol/Internet Protocol (TCP/IP) signals. In this embodiment of the present invention, the peripheral interface signals may be Peripheral Component Interconnect (Peripheral Component Interconnect Local Bus Specification, PCI—Special Interest Group, Revision 2.2 and 2.3, March 2001) (PCI) signals.

In another alternative embodiment of the present invention, the receiving module 202 in the universal conversion system 200 may receive the storage device access signals and transfer the storage device access signals to the conversion module 204. The universal conversion module 204 may convert the storage device access signals to peripheral interface signals and transfer the peripheral interface signals to the output module 206. In this embodiment of the present invention, the output module 206 may transmit the peripheral interface signals to the network interface device 110. In this embodiment of the present invention, the storage device access signals may be IDE signals. In this embodiment of the present invention, the peripheral interface signals may be Peripheral Component Interconnect (PCI) signals.

As is known in the art, the storage device access signals from the I/O device may be requesting a read or write operation from the storage device. Because the storage device may be located on the remote computing device 116, the storage device access signals may be redirected to the remote computing device 116. The contents of the storage device access signals may include, for example, a read request, the address to be read, and one or more control signals. In the embodiment of the invention where a universal conversion system 112 converts the storage device access signals to peripheral interface signals, the contents of the storage device access signals may not be changed. Instead, the universal conversion device may convert the read/write control signals of the storage device access signals into the control signals of the peripheral interface signals.

The formatting of the storage device access signals may be modified to allow the signals to be transported via a peripheral interface. In other words, the contents of the peripheral interface signals may also include the read request, the address to be read, and one or more control signals. Illustratively, if the storage device access signals are IDE signals and the peripheral interface signals are PCI signals, the IDE signals may be converted to PCI signals capable of being transmitted on the PCI bus. More specifically, the read or write IDE signals may be converted to PCI control signals. The universal conversion device 112 may take the IDE signals received on specific pins and convert these signals to conform with the PCI interface, e.g., transfer the data bits from pins 13-18 on an illustrative IDE interface to the appropriate pins on the PCI interface.

Similarly, in the embodiment of the invention where the universal conversion device 112 converts the storage device access signals to network interface signals, the contents of the storage device access signals may not be changed during the conversion. Instead, the formatting of the original storage device access signals may be modified to allow the signals to be transmitted via a network interface. Utilizing the example from above, the contents of the storage device access signals, i.e., the address to be accessed, the one or more control signals, and the read request, may not be changed, but the format of transmission may be changed. For example, in order to transmit IDE signals over a network interface utilizing TCP/IP, the IDE signals may need to be converted to the specific network protocol like TCP/IP, i.e., transformed from synchronous signals to packetized signals in order to be transmitted utilizing TCP/IP. The packetized signals, i.e., the network interface signals, may be sent to the remote computing device 116, where the address is utilized to locate the appropriate information.

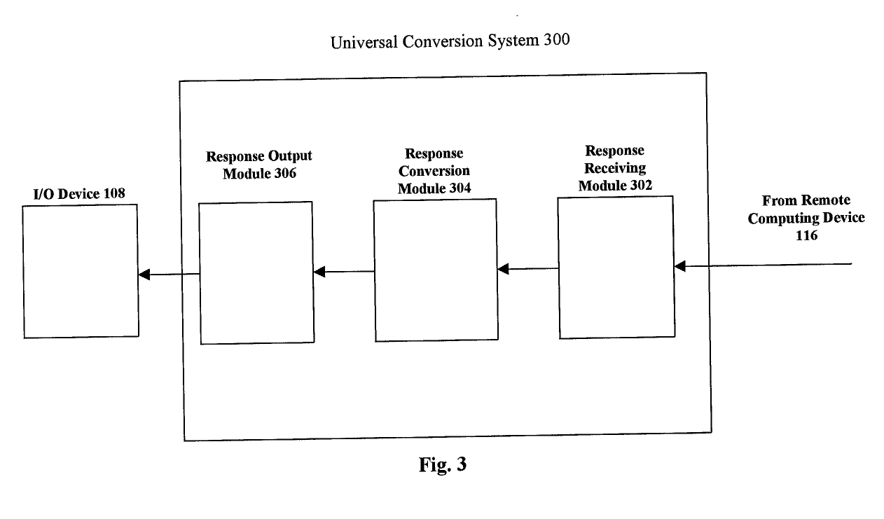

FIG. 3 illustrates a universal conversion system receiving information from a remote computing device according to an embodiment of the present invention. The remote computing device 116 may package information in the form of response network interface signals and forward information to the universal conversion system 300. The universal conversion system 300 may include a response receiving module 302, a response conversion module 304, and a response output module 306. In this embodiment of the present invention, the response receiving module 302 of the universal conversion system 300 may receive response network interface signals from the remote computing device 116. The response receiving module 302 may transfer the network interface signals to the response conversion module 304. In this embodiment of the present invention, the response conversion module 304 may convert the response network interface signals to storage device response signals. The response conversion module 304 may transfer the storage device response signals to the response output module 406. The response output module 406 may transmit the storage device response signals to the input/output device 108.

In an alternative embodiment of the present invention, the response receiving module 302 of the universal conversion system 300 may receive response network interface signals from the remote computing device 116. The response receiving module 302 may transfer the network interface signals to the response conversion module 304. In this embodiment, the response conversion module 304 may convert the response network interface signals to response peripheral interface signals and also may then convert the response peripheral interface signals to storage device response signals. The response conversion module 304 may transmit the storage device response signals to the response output module 306. In this embodiment of the invention, the response output module 306 may transmit the storage device response signals to the input/output device 108. In this embodiment of the invention, the universal conversion system 300 may be housed in the network interface device 110 (FIG. 1). In an embodiment of the present invention, the storage device response signals may be IDE signals. In an embodiment of the present invention, the peripheral interface signals may be PCI signals.

In an alternative embodiment of the present invention, the response receiving module 302 of the universal conversion system 300 may receive response peripheral interface signals from the network interface device 110. The response receiving module 302 may transfer the peripheral interface signals to the response conversion module 304. The response conversion module 304 may convert the response peripheral interface signals to storage device response signals and may transfer the storage device response signals to the response output module 306. The response output module 306 may transmit the storage device response signals to the input/output device 108. In an embodiment of the present invention, the storage device response signals may be IDE signals. In an embodiment of the present invention, the peripheral interface signals may be PCI signals.

As is well known in the art, the remote computing device 116 transmits a response back to the network interface device 110 in the form of response network interface signals, e.g., utilizing TCP/IP. In the embodiment of the invention where the universal conversion system 112 only converts response peripheral interface signals to storage device response signals, the network interface device 110 may receive the response TCP/IP signals, which are packetized. The network interface device 110 depacketizes the response TCP/IP signals, and converts the response TCP/IP signals into response PCI signals, i.e., response peripheral interface signals. When the network interface device 110 converts the response TCP/IP signals into response PCI signals, the contents are not modified. In other words, the response back from the remote computing device 116 may include at least one control signal, a plurality of data bits, and an address as to where to deliver the response. The network interface device 110 may only modify the format, structure or timing of the signals, and the response PCI signals may still contain the at least one control signal, a plurality of data bits and the address as to where to deliver the response.

Similarly, when the response peripheral interface signals, e.g., response PCI signals, are converted to storage device response signals, e.g., IDE response signals, by the universal conversion system 112, the contents of the signals are not changed, i.e., the control signal, the plurality of data bits, and the address remain the same. Instead, the format of the response peripheral interface signal is changed to the format of the storage device response signal to allow the information to be passed to the I/O device 108. The storage device response signals may be transmitted by the universal conversion system 112 to the I/O device 108 which passes the information, i.e., the plurality of the data bits to the address identified in the storage device response signals, e.g., the RAM 106.

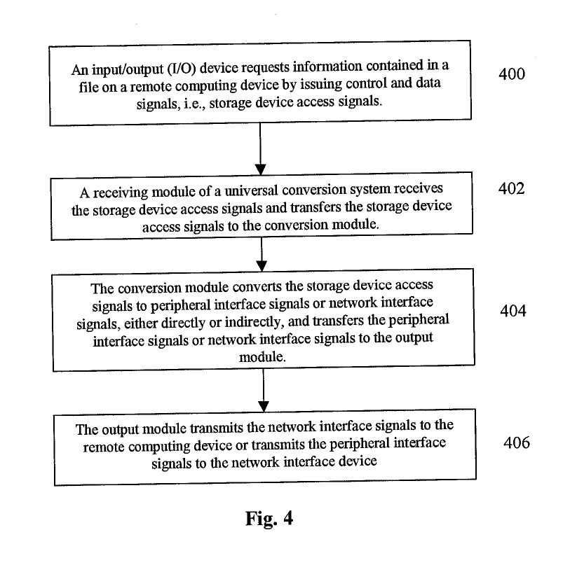

FIG. 4 illustrates a flowchart for a universal conversion system transmitting information to a remote computing device according to an embodiment of the present invention. An input/output (I/O) device 108 may request 400 information contained in a file on a remote computing device 116 by issuing control and data signals, i.e., storage device access signals. A receiving module 202 of the universal conversion system 200 may receive 402 the storage device access signals from the I/O device 108 and transfer the storage device access signals to the conversion module 204. In one embodiment of the present invention, the conversion module 112 may convert 404 the storage device access signals into peripheral interface signals and transfer the peripheral interface signals to the output module 206. In this embodiment of the present invention, the output module 206 may transmit 406 the peripheral interface signals to the network interface device 110. In another embodiment of the present invention, the conversion module 112 may convert 404 the storage device access signals into network interface signals, directly or indirectly, and transfer the network interface signals to the output module 206. In this embodiment of the present invention, the output module 206 may transmit 406 the network interface signals to the remote computing device 116.

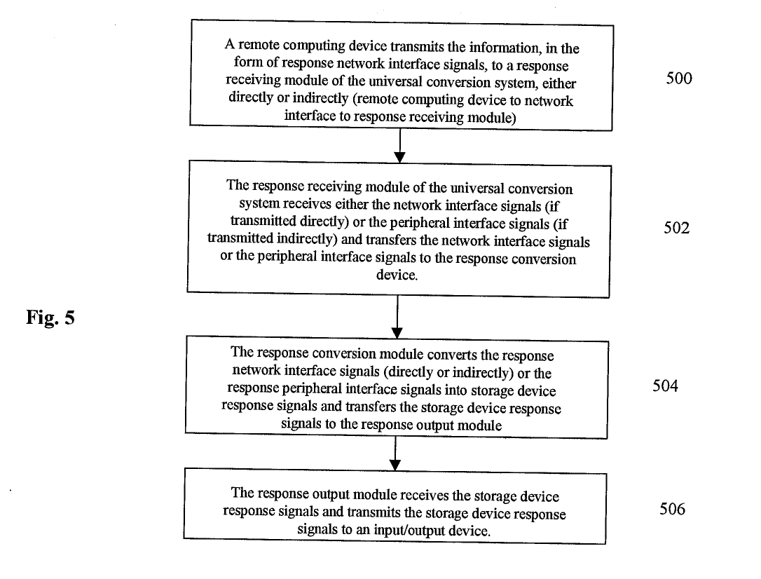

FIG. 5 illustrates a flowchart for a universal conversion system receiving information from a remote computing device according to an embodiment of the present invention. In one embodiment of the present invention, a remote computing device 116 may transmit 500 the information, in the form of response network interface signals, to a network interface device 110 via a communications network. In this embodiment of the present invention, the network interface device 110 may receive the response network interface signals, convert the network interface signals into response peripheral interface signals, and transmit the response peripheral interface signals to a response receiving module 302 of a universal conversion system 112. In another embodiment of the present invention, the remote computing device 116 may transmit 500 the response network interface signals to the response receiving module 302 of the universal conversion system 112. The response receiving module receives 502 either the response network interface signals or the response peripheral interface signals and transfers the response network interface signals or the response peripheral interface signals to the response conversion module 304. The response conversion module 304 converts 504 the response network interface signals, either directly or indirectly into storage device response signals, or converts the response peripheral interface signals into storage device response signals, and transfers the storage device response signals to the response output module 306. The response output module transfers 506 the storage device response signals to the I/O Device 108.

While the description above refers to particular embodiments of the present invention, it will be understood that many modifications may be made without departing from the spirit thereof The accompanying claims are intended to cover such modifications as would fall within the true scope and spirit of other embodiments of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are intended to be embraced therein.

What is claimed is:

1. A universal conversion system, comprising:
a receiving module to receive storage device access signals;
a conversion module to convert the storage device access signals to network interface access signals; and
an output module to output the network interface signals.

2. The universal conversion system of claim 1, wherein the storage device access signals are Integrated Drive Electronic (IDE) signals.

3. The universal conversion system of claim 1, wherein the network interface signals are Transmission Control Protocol/Internet Protocol (TCP/IP) signals.

4. The universal conversion system of claim 1, wherein the universal conversion system is located within a network interface device.

5. A universal conversion system, comprising:
a receiving module to receive storage device access signals;
a conversion module to convert the storage device access signals to peripheral interface signals and to convert peripheral interface signals into network interface signals; and
an output module to output the network interface signals.

6. The universal conversion system of claim 5, wherein the storage device access signals are Integrated Drive Electronics (IDE) signals.

7. The universal conversion system of claim 5, wherein the network interface signals are Transmission Control Protocol/Internet Protocol (TCP/IP) signals.

8. The universal conversion system of claim 5, wherein the universal conversion system is located within a network interface device.

9. A universal conversion system, comprising:
a receiving module to receive storage device access signals;
a conversion module to convert the storage device access signals to peripheral interface signals; and
an output module to output the peripheral interface signals to a network interface device.

10. The universal conversion system of claim 9, wherein the storage device access signals are Integrated Drive Electronics (IDE) signals.

11. The universal conversion system of claim 10, wherein the IDE signals are primary IDE signals.

12. The universal conversion system of claim 9, wherein the peripheral interface signals are Peripheral Component Interconnect (PCI) signals.

13. The universal conversion system of claim 9, wherein the universal conversion system is located within an application specific integrated circuit (ASIC).

14. A universal conversion system, comprising:
a response receiving module to receive response network interface signals;
a response conversion module to convert the response network interface signals to storage device response signals; and
a response output module to output the storage device response signals.

15. The universal conversion system of claim 14, wherein the storage device response signals are Integrated Drive Electronic (IDE) signals.

16. The universal conversion system of claim 14, wherein the response network interface signals are Transmission Control Protocol/Internet Protocol (TCP/IP) signals.

17. The universal conversion system of claim 14, wherein the universal conversion system is located within a network interface device.

18. A universal conversion system, comprising:
a response receiving module to receive response network interface signals;
a response conversion module to convert the response network interface signals to response peripheral interface signals and to convert the response peripheral interface signals into storage device response signals; and
a response output module to output the storage device response signals.

19. The universal conversion system of claim 18, wherein the storage device response signals are Integrated Drive Electronics (IDE) signals.

20. The universal conversion system of claim 18, wherein the response network interface signals are Transmission Control Protocol/Internet Protocol (TCP/IP) signals.

21. The universal conversion system of claim 18, wherein the universal conversion system is located within a network interface device.

22. A universal conversion system, comprising:
a response receiving module to receive response peripheral interface signals;
a response conversion module to convert the response peripheral interface signals to storage device response signals; and
a response output module to output the storage device response signals to an input/output device.

23. The universal conversion system of claim 22, wherein the storage device response signals are Integrated Drive Electronics (IDE) signals.

24. The universal conversion system of claim 23, wherein the IDE signals are primary IDE signals.

25. The universal conversion system of claim 22, wherein the peripheral interface signals are Peripheral Component Interconnect (PCI) signals.

26. The universal conversion system of claim 22, wherein the universal conversion device is located within an application specific integrated circuit (ASIC).

27. A computing device to transmit information to a remote computing device, comprising:
a processor to generate storage device request signals to request data from the remote computing device;
an input/output device to receive the storage device request signals from the processor, and to transmit the storage device access signals,
an universal conversion system, including
a receiving module to receive storage device access signals,
a conversion module to convert the storage device access signals to network interface signals,
an output module to transmit the network interface signals to the remote computing device, wherein the remote computing device retrieves information requested in the network interface signals.

28. The computing device of claim 27, wherein the universal conversion system is located within a network interface device.

29. A computing device to receive information from a remote computing device, comprising:
a universal conversion system, including,
a response receiving module to receive response network interface signals from the remote computing device,
a response conversion module to convert the response network interface signals to storage device response signals,
a response output module to transmit the storage device response signals, an input/output device to receive the storage device response signals and to transmit the storage device response signals,
a processor to receive the storage device response signals.

30. The computing device of claim 29, wherein the universal conversion system is located within the network interface device.

31. A method of converting storage device access signals, comprising:
receiving storage device access signals from an input/output device;
converting the storage device access signals to network interface signals; and
transmitting the network interface signals to the remote computing device.

32. The method of claim 31, wherein the storage device access signals are Integrated Drive Electronics (IDE) signals.

33. A method of converting storage device access signals, comprising:
receiving storage device access signals from an input/output device;
converting the storage device access signals to peripheral interface signals and converting the peripheral interface signals to network interface signals; and
transmitting the network interface signals to the remote computing device.

34. The method of claim 28, wherein the storage device access signals are Integrated Drive Electronics (IDE) signals.

35. A method of converting storage device access signals, comprising:
receiving storage device access signals from an input/output device;
converting the storage device access signals to peripheral interface signals; and
transmitting the peripheral interface signals to a network interface device.

36. The method of claim 35, wherein the storage device access signals are Integrated Drive Electronics (IDE) signals.

37. A method of converting network interface signals to storage device access signals, comprising:
receiving response network interface signals from a remote computing device;
converting the response network interface signals into storage device response signals; and
transmitting the storage device response signals to an input/output device.

38. The method of claim 37, wherein the storage device response signals are Integrated Drive Electronics (IDE) signals.

39. A method of converting network interface signals to storage device access signals, comprising:
receiving response network interface signals from a remote computing device;
converting the response network interface signals to response peripheral interface signals;
converting the response peripheral interface signals to storage device response signals; and
transmitting the storage device response signals to an input/output device.

40. The method of claim 39, wherein the storage device response signals are Integrated Drive Electronics (IDE) signals.

41. A method of converting response peripheral interface signals to storage device response signals, comprising:
receiving the response peripheral interface signals from a network interface device;
converting the response peripheral interface signals to storage device response signals; and
transmitting the storage device response signals to an input/output device.

42. The method of claim 41, where the storage device response signals are Integrated Drive Electronics (IDE) signals.

43. A program code storage device, comprising:
a machine-readable storage medium; and
machine-readable program code, stored on a machine-readable storage medium, the machine-readable program code having instructions to
receive storage device access signals from an input/output device;
convert the storage device access signals to network interface signals; and
transmit the network interface signals to the remote computing device.

44. The program code storage device of claim 43, wherein the storage device access signals are Integrated Drive Electronics (IDE) signals.

45. A program code storage device, comprising:
a machine-readable storage medium; and
machine-readable program code, stored on a machine-readable storage medium, the machine-readable program code having instructions to
receive storage device access signals from an input/output device;
convert the storage device access signals to peripheral interface signals and convert the peripheral interface signals to network interface signals; and
transmit the network interface signals to the remote computing device.

46. The program code storage device of claim 45, wherein the storage device access signals are Integrated Drive Electronics (IDE) signals.

47. A program code storage device, comprising:
a machine-readable storage medium; and
machine-readable program code, stored on a machine-readable storage medium, the machine-readable program code having instructions to
receive storage device access signals from an input/output device;
convert the storage device access signals to peripheral interface signals; and
transmit the peripheral interface signals to a network interface device.

48. The program code storage device of claim 47, wherein the storage device access signals are Integrated Drive Electronics (IDE) signals.

49. A program code storage device, comprising:
a machine-readable storage medium; and
machine-readable program code, stored on a machine-readable storage medium, the machine-readable program code having instructions to
receive response network interface signals from a remote computing device;
convert the response network interface signals into storage device response signals; and
transmitting the storage device response signals to an input/output device.

50. The program code storage device of claim 49, wherein the storage device access signals are Integrated Drive Electronics (IDE) signals.

51. A program code storage device, comprising:
a machine-readable storage medium; and
machine-readable program code, stored on a machine-readable storage medium, the machine-readable program code having instructions to
receive response network interface signals from a remote computing device;
convert the response network interface signals to response peripheral interface signals;
convert the response peripheral interface signals to storage device response signals; and
transmit the storage device response signals to an input/output device.

52. The program code storage device of claim 51, wherein the storage device access signals are Integrated Drive Electronics (IDE) signals.

53. A program code storage device, comprising:
a machine-readable storage medium; and
machine-readable program code, stored on a machine-readable storage medium, the machine-readable program code having instructions to
receive the response peripheral interface signals from a network interface device;
convert the response peripheral interface signals to storage device response signals; and
transmit the storage device response signals to an input/output device.

54. The program code storage device of claim 53, wherein the storage device access signals are Integrated Drive Electronics (IDE) signals.
